(19) United States
(12) Patent Application Publication
(10) Pub. No.: US 2002/0035576 A1
(43) Pub. Date: Mar. 21, 2002

(54) Information presenting apparatus, information presenting method and information presenting program recording medium

(75) Inventors: Toyoaki Kishimoto, Tokyo (JP); Yusuke Tani, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SONY CORPORATION, SHINAGAWA-KU (JP)

(21) Appl. No.: 09/945,669

(22) Filed: Sep. 5, 2001

(30) Foreign Application Priority Data
Sep. 7, 2000 (JP) 2000-272198

(51) Int. Cl. G06F 17/30; G06F 15/16

(52) U.S. Cl. 707/200; 709/206; 707/10

(57) ABSTRACT

A mail server employed in a client service provider receives an email destined for a user cataloged in advance in the client service provider. If the email has a file attached thereto, the format of the attached file is examined. If the format of the attached file is found to be a format categorized as a format of a first file format group set in advance, the format is converted into another format belonging to a category other than the first file format group, that is, a second file format group set in advance. Then, the attached file is replaced by a file having the other format.

As a result, by using a mail viewing terminal, the user is capable of viewing the attached file without installing various kinds of software specially used for displaying and viewing files which are attached to emails and have a variety of formats.

### BACKGROUND OF THE INVENTION

The present invention relates to an information presenting apparatus for converting the format of a file attached to an electronic mail exchanged through typically the Internet into a standard format and presenting the file to a mail viewing terminal as well as relates to an information presenting method adopted by the information presenting apparatus and an information presentation processing program storage medium for storing a program implementing the information presenting method.

An electronic mail referred to hereafter simply as an email contains a message expressed in terms of characters as main contents. Such an email can of course be transmitted through the Internet. In addition, an electronic file containing a variety of messages, pictures or the like can also be transmitted as an attachment to an email. That is to say, while the main contents of a transmitted email are generally information expressed in terms of characters such as a text, a file attached to a transmitted email can have any format.

In a mail viewing terminal receiving an email, however, a file attached to an email cannot be opened unless the terminal is provided with software capable of viewing a file having the same format as the attached file. Such software is the same application as a created application of the attached file or viewer software capable of viewing a file having the format of the attached file.

In a portable information terminal called a PDA (Personal Digital Assistant), for example, an application usable in the PDA does not even exist. Thus, a file attached to an email at great pains cannot be displayed in some cases. In addition, the number of pieces of application software is limited due to limitation on the storage capacity of the PDA. In this condition, it is therefore difficult to view a file having any arbitrary format.

It should be noted that a number of personal computers (PCs) purchased in recent years each have various kinds of application software to a certain degree as a standard. Furthermore, additional software can also be newly installed later easily. Thus, while the problem described above arises less frequently, the problem still exists.

### SUMMARY OF THE INVENTION

It is thus an object of the present invention addressing the problem described above to provide an information presenting apparatus making a mail viewing terminal capable of viewing any attached files with no need to install various kinds of software for viewing emails' attached files having a variety of file formats as well as relates to an information presenting method adopted by the information presenting apparatus and an information presentation processing program storage medium for storing a program implementing the information presenting method.

In order to achieve the object described above, the present invention provides an information presenting apparatus characterized in that the information presenting apparatus comprises:

a format recognizing means for recognizing a type of a format of an attached file attached to an email destined for a user cataloged in advance;

a format conversion processing means which is used for converting the format of the attached file into a particular standard format pertaining to a second format group set in advance if the format of the attached file is recognized by the format recognizing means to be a format pertaining to a first format group set in advance; and

a file replacement processing means for replacing the attached file attached to the email with another attached file having the particular standard format produced by the format conversion processing means as a result of format conversion.

In the configuration described above, the format of an attached file is converted into a standard format of a file to serve as a substitute for the attached file and a mail viewing terminal is provided with software installed in advance for viewing a document having the standard format so that the attached file having any format different from the standard format can be viewed.

As an example, assume that the first format group includes a format group for text files and a format group for moving picture and/or audio files. If the format recognizing means recognizes the format of an attached file as the first format group's format for text files, the format conversion processing means converts the format of the attached file into a second format group's standard format provided in advance for text files. If the format recognizing means recognizes the format of an attached file as the first format group's format for moving picture and/or audio files, on the other hand, the format conversion processing means converts the format of the attached file into the second format group's standard format provided in advance for moving picture and/or audio files.

The configuration described above may be further provided with a mail preserving means for preserving emails destined for users cataloged in advance and a massage insertion processing means which is used for inserting a message notifying the user that format conversion was not carried out into the main contents of an email preserved in the mail saving means in case the format recognizing means recognizes the format of the attached file as neither the first format group's format provided in advance for text files nor the first format group's format provided in advance for moving picture and/or audio files.

In accordance with the wish of the user, the configuration described above may be further provided with a storage means for storing the first format group' formats not to serve as an object of conversion as desired by the user and, if the format recognizing means recognizes the format of an attached file as the first format group's format not to be converted, the format conversion processing means does not convert the format of the attached file into a standard format.

In accordance with the present invention, a mail viewing machine is made capable of viewing any arbitrary files such as a text file and a moving picture file without installing various kinds of software for viewing an attached file accompanying an email and having any arbitrary format. Thus, the mail viewing machine provided by the present invention is particularly useful to a user who can afford to own only an apparatus with a small storage capacity like a portable information terminal or a mobile phone. In addition, for a service provider which renders services of providing viewable files to users, the present invention is useful as an value added service for gaining more customers.

### BRIEF DESCRIPTION OF THE DRAWINGS

FIG. 1 is a diagram showing a typical overall configuration of a system implemented by an embodiment of the present invention;

FIG. 2 is a block diagram showing a hardware configuration of a PDA of the embodiment of the present invention in a simple and plain manner;

FIG. 3 is a block diagram showing a general hardware configuration of a server in each provider in the embodiment of the present invention a simple and plain manner;

FIG. 4 is a diagram showing a typical internal system configuration of a client service provider employed in the embodiment of the present invention;

FIG. 5 is a diagram showing a table configuration of a customer management database of the client service provider employed in the embodiment of the present invention;

FIG. 6 is a flowchart representing the procedure of typical processing carried out by the client service provider employed in the embodiment of the present invention to catalog a format not to be converted;

FIG. 7 is a diagram showing an initial screen in an initial online state of a PDA employed in the embodiment of the present invention;

FIG. 8 is a diagram showing a typical PDA screen showing mail related menu items in the embodiment of the present invention;

FIG. 9 is a diagram showing a typical screen displaying a customize input form related to conversion of the format of a file in the embodiment of the present invention; and

FIG. 10 is a flowchart representing the procedure of processing carried out by a mail server employed in the embodiment of the present invention to receive an email along with processing to convert the format of a file attached to the email.

### PREFERRED EMBODIMENT OF THE INVENTION

A preferred embodiment of the present invention is described by referring to diagrams as follows.

While the present invention is suitable for an application in which a mail is received by a portable terminal such as a PDA, the invention can also be applied to a case in which an email is received by an ordinary PC or the like. In addition, the present invention can also be applied to a case in which an email is received by a portable terminal such as a mobile phone or a PHS (Personal Handy-phone System).

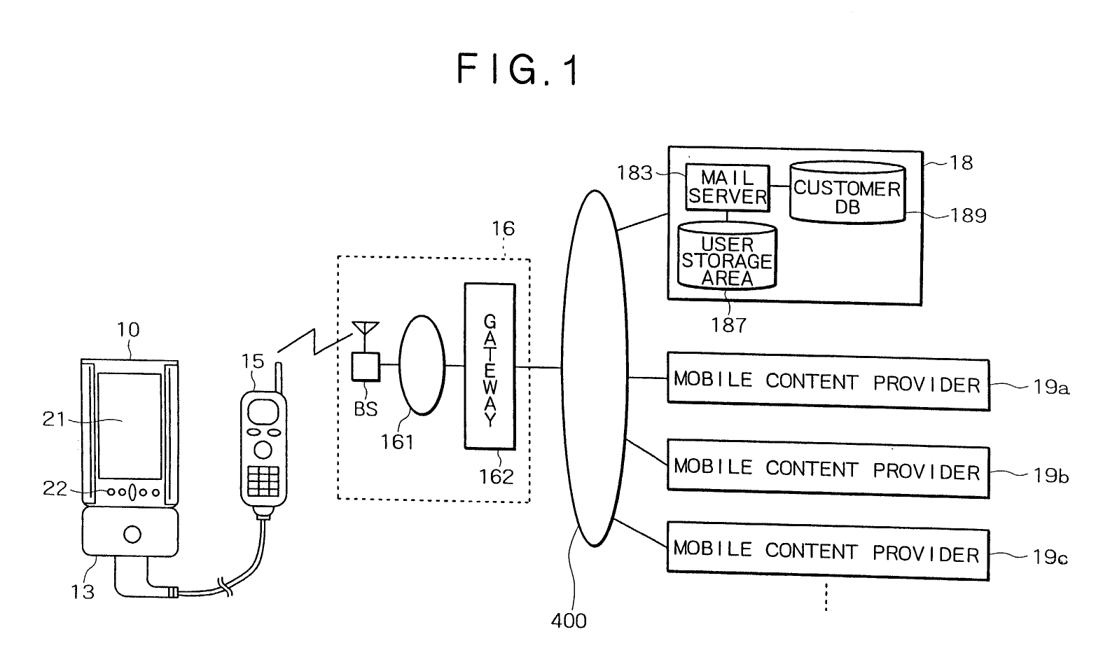

When used in conjunction with a communication apparatus such as a mobile phone 15 as shown in FIG. 1, a contemporary PDA 10 which is not so handy and portable as the mobile phone 15 is superior to the mobile phone 15 in that the PDA 10 can be used at an unlimited number of locations as far as the locations are within a range reachable by an electric wave and the PDA 10 has a display screen with a large size, a relatively large storage size as well as a number of auxiliary functions. For this reason, the embodiment of the present invention is exemplified by a case in which the PDA 10 is used as a mail viewing terminal.

FIG. 1 is a diagram showing a typical overall configuration of a system implemented by the embodiment of the present invention. The technical term “system” used in this specification means a logical set of a plurality of apparatuses. Apparatuses in the configuration of a system may or may not physically exist in the same case. In this embodiment, the user utilizes the PDA 10 to make an access to a client service provider 18, which functions as the so-called portal site for information portable terminals, through the Internet 400. The user must have been cataloged in the client service provider 18.

The Internet 400 is also connected to a variety of servers including mobile content servers 19a, 19b and 19c for communicating various kinds of information to the PDA 10 and the like. It should be noted that the connection of the Internet 400 to the mobile content servers 19a, 19b and 19c is not directly related to the present invention.

The main body of the PDA 10 shown in FIG. 1 has an all but rectangular shape with such a height that an adult's one hand with a standard size is capable of grasping both the sides of the main body. The front surface of the main body is mainly occupied by a display unit 21. A touch pad not seen in the figure is provided on the top of the display unit 21. Below the surface of the display unit 21, hardware keys 22 are laid out. The main body also has a stylus or a pen, which can be kept/inserted inside/into the main body, as an accessory. The stylus or the pen is also not shown in the figure. The user is capable of pointing to a position on the touch pad by using this stylus. The user is also capable of entering a hand-written character or a hand-drawn picture to the PDA 10 by using the stylus. In addition, a memory stick (Sony Corporation's trademark) to be described later can be plugged into or pulled out from a slot provided on the top surface of the main body. A portion of a jog dial also to be described later protrudes out off a dent provided on the upper part of the left side surface of the main body. The portion of the jog dial is not shown in the figure either. The jog dial is installed on the main body in such a way that the user is capable of rotating and pressing the jog dial by bending and stretching the thumb of the left hand grasping the PDA 10.

In the configuration of the system provided by the present invention, the client service provider 18 has a mail server 183, a customer database (DB) 189 and a user storage area 187. The mail server 183 manages, transmits and receives emails. The customer DB 189 is a DB for storing various kinds of personal information on users of PDAs 10. The personal information includes information on formats not to be converted as will be described later. The user storage area 187 includes mailboxes provided specially for individual users. Concrete configurations of the mail server 183, the customer DB 189 and the user storage area 187 will be described later. The customer DB 189 can be stored in the same HDD (Hard Disk Drive) as the user storage area 187 or in a different one.

In order to connect the PDA 10 to the Internet 400 in this embodiment, the PDA 10 is connected to the mobile phone 15 through a communication adapter 13. The mobile phone 15 is connected to a mobile network 161 of an Internet connection provider 16 through a predetermined base station BS and further connected to the Internet 400 through a gateway 162 of the Internet connection provider 16.

In the embodiment shown in FIG. 1, the Internet connection provider 16 is physically separated from the client service provider 18. However, the Internet connection provider 16 and the client service provider 18 can also be implemented by a single provider.

The following description concretely explains a typical configuration of each component in the system. The description is followed by an explanation of typical concrete operations.

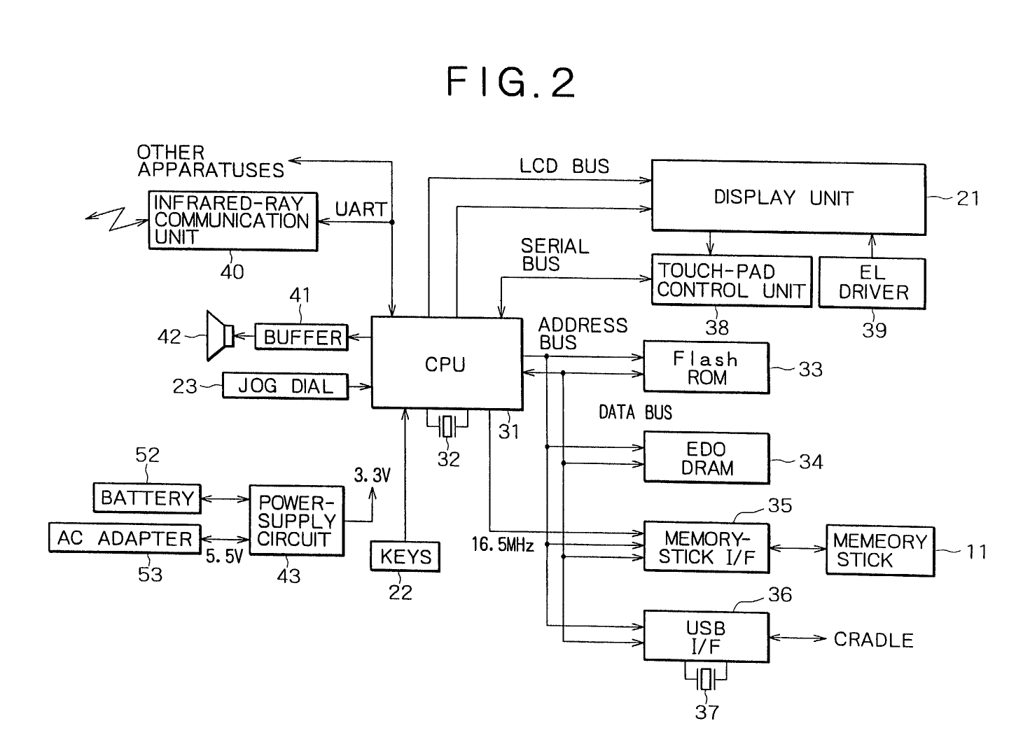

FIG. 2 is a block diagram showing the hardware configuration of the PDA 10 of the embodiment in a simple and plain manner. A CPU (Central Processing Unit) 31 executes a variety of programs synchronously with a clock signal received from an oscillator 32. The programs include application programs, an operating system and the like which are stored in a flash ROM (Read-Only Memory) 33 and an EDO DRAM (Extended Data Out Dynamic RandomAccess Memory) 34. In this embodiment, the application programs include a viewer program capable of viewing a file with a specific format. An example of the viewer program is the Acrobat Reader Mobile Edition developed by Adobe System of the USA for PDA use. This program is capable of viewing a PDF (Portable Document Format) file. The PDF is one of standard file formats each obtained as a result of format conversion carried out by the mail server 183 to be described later. Contents of a PDF file can be displayed and printed by an acrobat reader. The PDF allows a text file to be exchanged between an environment in which the text file is created and another environment. An environment implies elements such as the type of a machine, an OS (Operating System), an application and a font. In particular, a PDF text file can be used for saving a text with the original print image of the text kept as it is. Thus, a PDF text file is characterized in that information such as the original text's layout, font and ornament is preserved. In addition, the application programs also include a moving picture viewer program capable of playing back and displaying a moving picture.

The following description explains a moving picture viewer program called CLIE (Sony Corporation's trademark) which is executed on a PDA.

The CLIE moving picture viewer program is executed in the PDA under an OS called Palm OS (a trademark of Palm Inc. of the US and Palm Computing K. K.). Also installed in advance in the PDA is moving picture playback application software called gMedia (a trademark of Generic Media, Inc of the US) and used for playing back and displaying a moving picture file under Palm OS. To be more specific, the gMedia moving picture playback application software is capable of playing back a moving picture file having an original format, that is, a gMedia format.

Assume that a moving picture file stored in the PC is to be played back by using the CLIE moving picture viewer program. The file has any of a variety of formats such as MPEG1, AVI and QuickTime 3.0/4.0 (a trademark of Apple Corporation of the US). In the PC, the moving picture file is first converted into a moving picture file having the gMedia format. The moving picture file having the gMedia format is then copied to the CLIE moving picture viewer program, which is capable of playing back and displaying the file with ease, through a cradle.

It should be noted that, in place of the gMedia moving picture playback application software, other moving picture display software can also be executed in the PDA 10 under Palm OS. An example of the other moving picture display software is FireViewer5 announced by Firepad, Inc. of the US on Sep. 1, 2000.

In this embodiment, a moving picture viewer program such as gMedia described above is capable of playing back a moving picture file having the gMedia format which is one of standard formats each obtained as a result of format conversion carried out by the mail server 183 to be described later. The moving picture viewer program is stored in a flash ROM 33 or an EDO DRAM 34.

In addition, in this embodiment, audio playback application software serving as an audio playback program for playing back an audio file having an original format under Palm OS is stored in the flash ROM 33 or the EDO DRAM 34. This audio playback application software is capable of playing back an audio file having an original format which is one of standard formats each obtained as a result of format conversion carried out by the mail server 183 to be described later.

The flash ROM 33 is a flash memory which is a kind of EEPROM (Electrically Erasable Programmable Read-Only Memory). An EEPROM is an electrically erasable programmable non-volatile memory. In general, the flash ROM 33 is used for storing programs to be executed by a CPU 31 and storing processing parameters that basically have constant values.

Controlled by the CPU 31, a memory stick I/F unit 35 reads out data from a memory stick 11 mounted on the PDA 10 and writes data received from the CPU 31 into the memory stick 11.

Controlled by the CPU 31, a USB (Universal Serial Bus) interface unit 36 inputs data or a program from an external PC (personal computer) through a connected cradle not shown in the figure synchronously with a clock signal received from an oscillator 37. On the other hand, also controlled by the CPU 31, the USB interface unit 36 supplies data received from the CPU 31 to the external PC by way of the cradle.

The flash ROM 33, the EDO DRAM 34, the a memory stick I/F unit 35 and the USB interface unit 36 are connected to the CPU 31 by an address bus and a data bus.

The display unit 21 employed in this embodiment is a liquid crystal display unit which receives data from the CPU 31 through an LCD bus. The display unit 21 displays a picture and/or characters representing the received data. When the touch pad provided on the top of the display unit 21 is operated, a touch pad control unit 38 receives data representing the operation carried out on the touch pad from the display unit 21 and supplies a signal representing the data to the CPU 31 through a serial bus. The data is typically coordinates of a touched position on the touch pad.

An EL (electroluminescence) driver 39 drives an electric field light emitting device provided on the rear side of the display unit 21 in order to control the brightness of the display unit 21.

An infrared-ray communication unit 40 transmits data received from the CPU 31 through a UART (Universal Asynchronous Receiver Transmitter) as an infrared ray used as communication media to another apparatus not shown in the figure, and receives infrared-ray data from the other apparatus and supplies the data to CPU 31. In addition, the PDA 10 is also capable of communicating with the other apparatus through UART.

An audio generation unit 42 comprises an audio data decoding circuit and a speaker. The audio generation unit 42 decodes audio data stored in advance or received from the Internet 400, plays back a result of decoding and outputs a sound. For example, the audio generation unit 42 plays back audio data received from the CPU 31 through a buffer 41, and outputs a sound based on the audio data.

Keys 22 includes input keys of the hardware. The keys 22 are operated by the user to enter a variety of commands. A jog dial 23 is a rotatable push switch rotated or pressed to enter data to the CPU 31.

A power supply circuit 43 converts a power supply voltage received from a mounted battery 52 and an AC (Alternating Current) adapter 53 into a predetermined power supply voltage to be supplied to a variety of components composing the PDA 10.

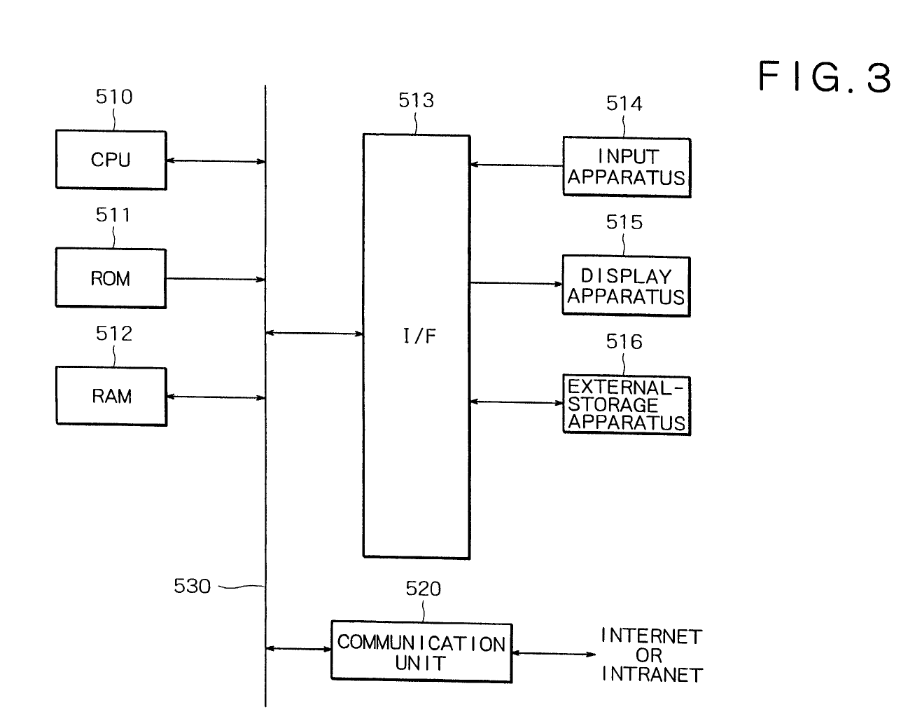

FIG. 3 is a block diagram showing a general hardware configuration of a server in each provider in a simple and plain manner. A CPU 510 executes an OS and a variety of application programs to control components of the server. A ROM 511 is used for storing programs to be executed by the CPU 510 and storing processing parameters that basically have constant values. A RAM 512 includes a work area used by the CPU 510 and a storage area for temporarily storing data. The ROM 511 and the RAM 512 are connected to the CPU 510 by a bus 530. An input unit 514 such as a keyboard, a display unit 515 such as a CRT or a liquid crystal display unit, a hard disk drive and an external storage drive 516 for driving an MO disk or a CD-ROM are connected to the bus 530 by an interface unit 513. The bus 530 is connected to the Internet 400 or an intranet such as a LAN by a communication unit 520.

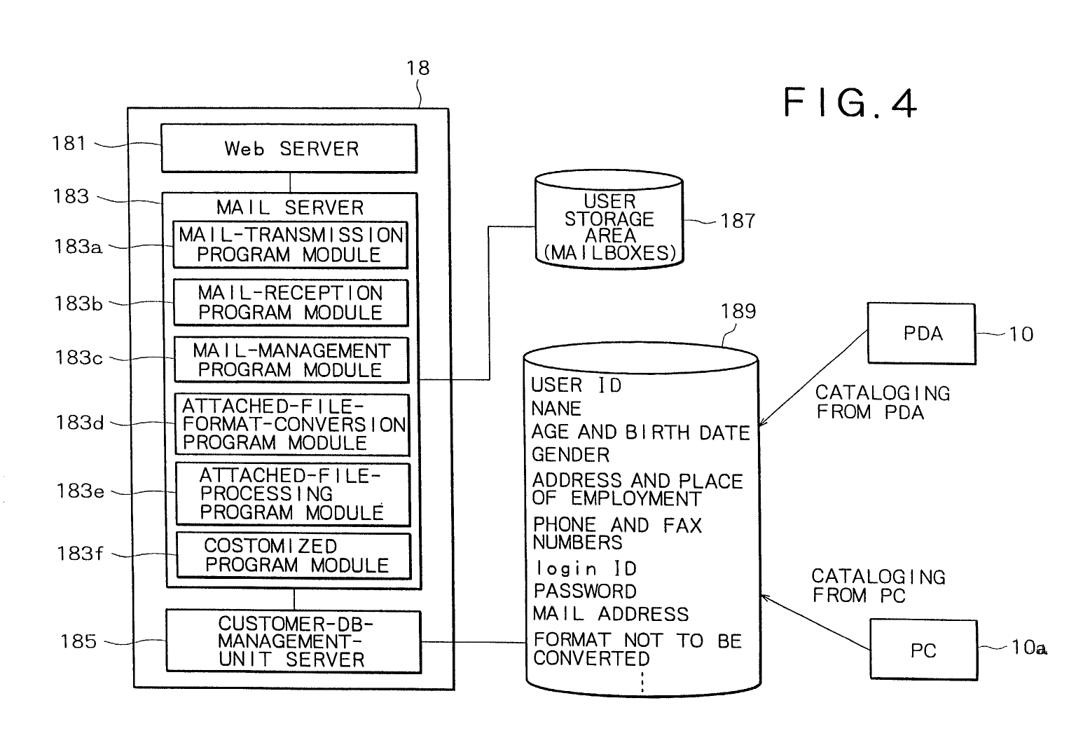

FIG. 4 is a diagram showing a typical internal system configuration of the client service provider 18. In addition to the mail server 183, the user storage area 187 and the customer DB 189 which are described earlier, the client service provider 18 also includes a customer DB management server 185 for managing the customer DB 189 and a web server 181. The web server 181 is a server for providing a client with a text file containing a text written in a markup language such as an HTML (Hyper Text Markup Language) in accordance with an http (Hyper Text Transfer Protocol). The customer DB management server 185 is a server for carrying out processing such as cataloging, updating and deletion of personal information in the customer DB 189.

The mail server 183 has a mail transmission program module 183a, a mail reception program module 183b, a mail management program module 183c, an attached file format conversion program module 183d, an attached file processing program module 183e and a customized program module 183f. The mail transmission program module 183a, the mail reception program module 183b and the mail management program module 183c provide native functions of the mail server 183. On the other hand, the attached file format conversion program module 183d, the attached file processing program module 183e and the customized program module 183f are a characteristic of this embodiment. The attached file format conversion program module 183d includes a group of conversion programs for converting a variety of existing file formats of text files, moving picture files and audio files into a standard format of a conversion result file. The existing file formats will be described later. The standard format of a conversion result file can be a PDF file format allowing the conversion result file to be viewed by using the acrobat reader mobile edition, a gMedia format allowing the conversion result file to be viewed by using the gMedia moving picture playback application software or an original format allowing the conversion result file to be viewed by using an audio playback program. The attached file processing program module 183e carries out processing such as verification of the format of an attached file, issuance of a command to convert the format of an attached file and replacement of the attached file. The customized program module 183f receives data representing setting of options of the mail server 183 from the user through the web server 181. The customized program module 183f also carries out processing such as addition of user customize information to the customer DB 189 and operations to update user customize information cataloged in the customer DB 189 through the customer DB management server 185.

Personal information cataloged in the customer DB 189 is information on each registered user. For each registered user, the information includes a name, an age and a birth date, a gender, an address, a place of employment, phone and fax numbers, a login ID for Internet connection, a password, a mail address and a format not to be converted. In addition, the information may include the accounting ID assigned to the user. The accounting ID is related to an operation to render a fee charging service to the user.

As a condition for the user of the PDA 10 to be entitled to a service to convert the format of an attached file, the user must first of all catalog the user itself in the client service provider 18. The user can catalog itself by written application, by phone or online which is fast and simple. An online operation to catalog a user can be carried out from the PDA 10 or an external apparatus such as the personal computer (PC) 10a. If a user is cataloged from the PC 10a, characters for cataloging can be entered with ease.

It should be noted that a user can also be cataloged separately from an operation to catalog the user for a service to convert the format of an attached file. This is because an operation to catalog the user for a service to convert the format of an attached file may be an optional service which can be selectively utilized by a cataloged user of the client service provider 18.

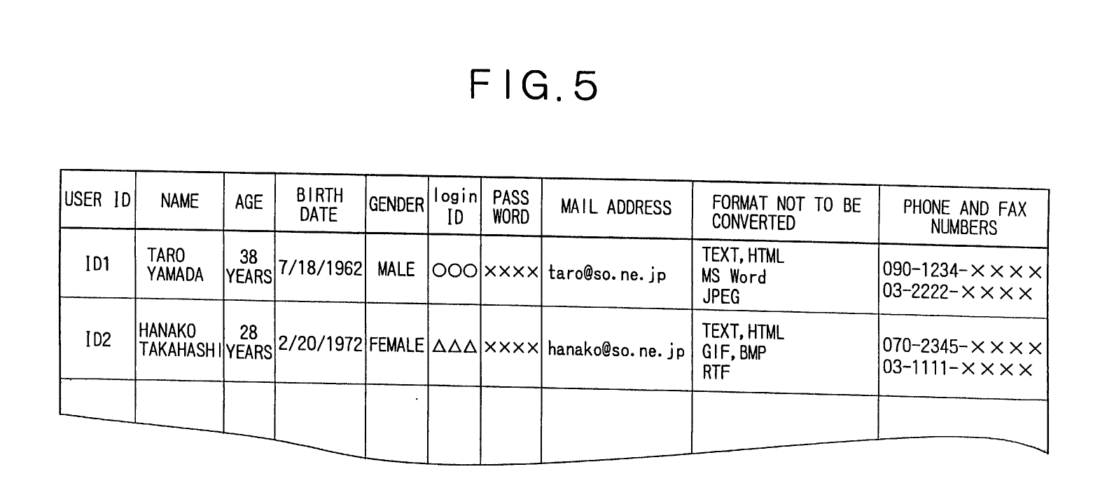

The customer DB 189 includes a record for each user ID in a table format shown in FIG. 5. The record includes items such as a name, an age and a birth date, a gender, an address, a place of employment, phone and fax numbers, a login ID for Internet connection, a password, a mail address and a format not to be converted as described above. A format not to be converted is the format of a file attached to an email destined for the user. A format recorded in the record as such is a format that is not to be converted. A file's format which is considered to allow any mail viewing machine to decode and display the file can be recorded by the mail server 183 as a default format not to be converted. An example of the default format is a text format. However, even in the case of such a default format, that is, even in the case of a text format, for example, the user may desire to treat the text as a text of the PDF format. Thus, the user may desire a scheme whereby a format recorded as a default format can be deleted from the“format not to be converted” record.

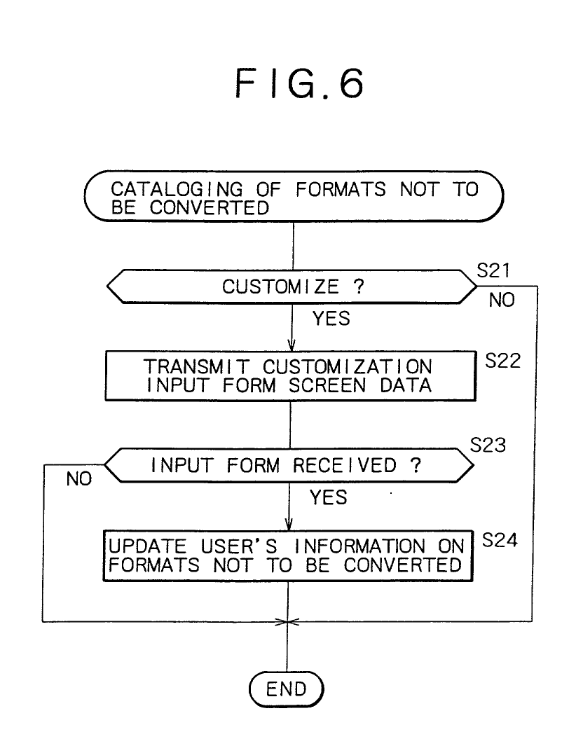

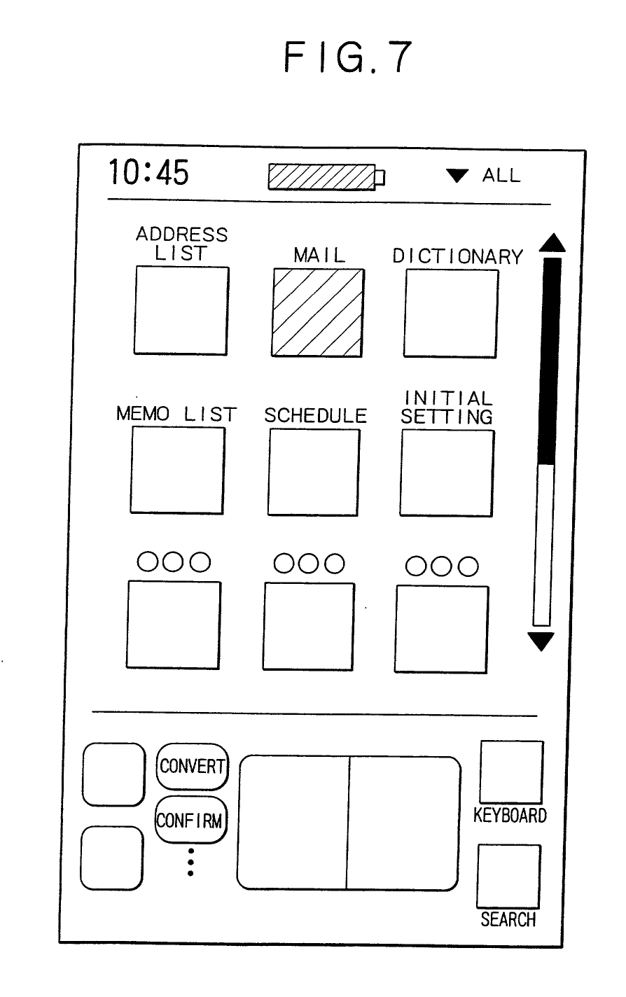

The following description explains the procedure of processing carried out by the client service provider 18 to catalog a format not to be converted by referring to a flowchart shown in FIG. 6 and typical PDA screens shown in FIGS. 7 to 9.

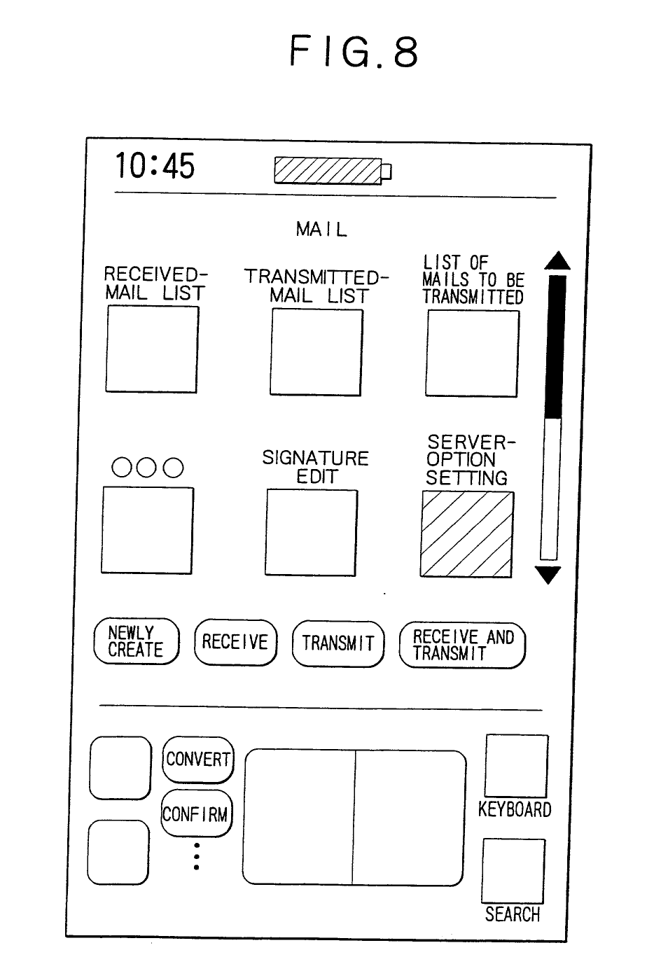

FIG. 7 is a diagram showing an initial screen in an off line state of the PDA 10. As shown in the figure, the initial screen displays a variety of menu items such as an address list, a mail, a dictionary, a memo list, a schedule and initial setting as icons. This screen is displayed on a portion of the display unit 21 of the PDA 10 shown in FIG. 1. The lower portion of the screen includes an input area for entering hand-written characters to be recognized. Assume that the user selects the mail icon from the menu items by using a stylus or by operating the jog dial. In this case, menu items related to mails are displayed as shown in FIG. 8. Assume that a “Server option setting” icon is selected from menu items displayed on the screen shown in FIG. 8. In this case, a web browser is activated and, with the PDA 10 connected to the mobile phone 15, the Internet connection provider 16 is dialed up for connection. Then, the user enters a login ID and a login password in order to establish a connection to the Internet 400. With such a connection established, an access to the web server 181 employed in the client service provider 18 is made. A site displayed on the screen is a home site set in advance as a default site or selected in accordance with an operation carried out by the user.

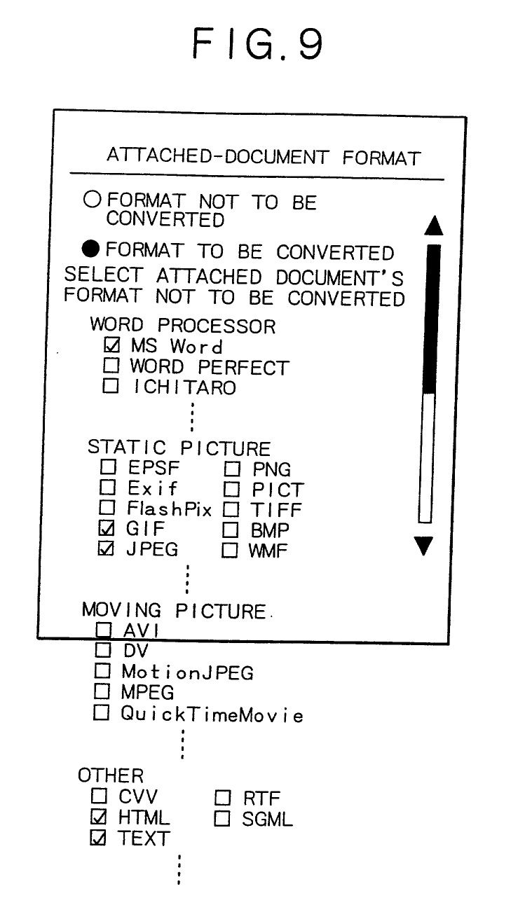

When the“Server option setting” icon of the mail related screen shown in FIG. 8 is operated, a“Server option setting” screen not shown in any figures is displayed and processing represented by the flowchart shown in FIG. 6 is started. The flowchart begins with a step S21 to form a judgment as to whether or not the user has further selected a customize menu item. If the outcome of the judgment formed at the step S21 is Yes indicating that the user has further selected a customize menu item, the flow of the processing goes on to a step S22 at which data of a customize input form screen related to conversion of a file format like one shown in FIG. 9 is transmitted to the PDA 10. Information displayed outside the frame of the screen shown in FIG. 9 can be moved to the inside of the frame by scrolling the screen.

With the typical screen of FIG. 9 displayed, the user is allowed to determine whether or not a format is to be converted. If the“Format not to be converted” menu item is selected, the format of a file attached to an email destined for the user will not be converted. If the “Format to be converted” menu item is selected, on the other hand, the format of a file attached to an email destined for the user will be converted. In this case, a file format or a plurality of file formats not to be converted are displayed individually in a form that allows each of the formats to be specified by a check mark. Attached files are classified into a text file prepared by a word processor, static picture, moving picture and other files which each have a variety of file formats as shown in the figure. For example, a text contained in a word processor file can be a text created by an MS Word word processor made by Microsoft Corporation or a text created by an Ichitaro word processor made by Just System. A text created by an MS Word word processor made by Microsoft Corporation and a text created by an Ichitaro word processor made by Just System have peculiar file formats. A static picture file can have a BMP, EPSF, Exif, FlashPix, GIF, JPEG, PNG, PICT, TIFF or other format. A moving picture file can have an AVI, DV, MotionJPEG, MPEG, QuickTimeMovie or other format. The remaining files can have CSV, HTML, RTF, SGML, SYLK and other formats. The mail server 183 converts the format of a text or a static picture into a standard PDF format and the format of a moving picture into the standard gMedia format described earlier. In addition, the mail server 183 has a conversion program installed therein in advance to be executed for converting the format of an audio file into an original format.

Refer back to the flowchart shown in FIG. 6. The flow of the processing then goes on to a step S23 to form a judgment as to whether or not filled-up form data has been received from the client side. If the outcome of the judgment formed at the step S23 is YES indicating that filled-up form data has been received from the client side, the flow of the processing goes on to a step S24 at which the user information stored in the customer DB 189 as shown in FIG. 5 is updated to include not-to-be-converted formats specified in the filled-up form or delete not-to-be-converted formats from the user information.

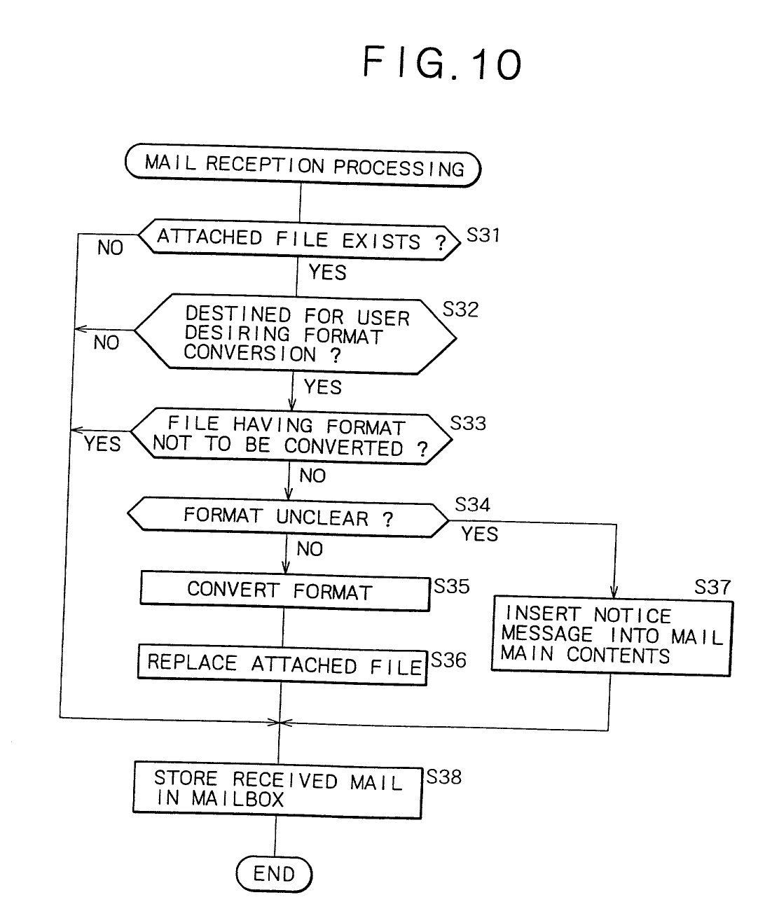

FIG. 10 is a flowchart representing the procedure of processing carried out by the mail server 183 to receive an email along with processing to convert the format of a file attached to the email. The processing to receive an email is carried out by the mail server 183 when the email is destined for a registered user. As shown in the figure, the flowchart begins with a step S31 to form a judgment as to whether or not a file is attached to a received email. If no file is attached to a received email, the flow of the processing goes on to a step S38 at which the received email is put in the user's mailbox in the user storage area as it is. If a file is attached to a received email, on the other hand, the flow of the processing goes on to a step S32 to form a judgment as to whether or not the user serving as the recipient of the received email desires conversion of the format of the attached file. The formation of the judgment is based on the user information stored in the customer DB 189. If the user serving as the recipient of the received email does not desire conversion of the format of the attached file, the flow of the processing goes on to the step S38 at which the received email is put in the user's mailbox in the user storage area as it is. If the user serving as the recipient of the received email desires conversion of the format of the attached file, on the other hand, the flow of the processing goes on to a step S33 to form a judgment as to whether or not the format of the attached file is the format not to be converted. The judgment is formed by referring to the customer DB 189 for the user's formats not to be converted to determine whether the format of the attached file matches one of the cataloged formats not to be converted. Normally, the format of an attached file can be determined from the extension of a file name given to the file. The extension of a file name is a string of characters following a dot at the end of the file name. Examples of the extension are txt, doc and gif. If the format of the attached file does not match any one of the formats not to be converted, on the other hand, the flow of the processing goes on to the step S34 to form a judgment as to whether or not the file of the attached file is unclear. An example of the unclear format is the format of a file with no file name extension. Another example of the unclear format is the format of a file with a file name extension having a character string which does not match the extension for any pre-conversion format convertible by the attached file format conversion program module 183d. If the format of the attached file is unclear, the flow of the processing goes on to a step S37 at which a text of a notification message is inserted into the main contents of the email. The notification message informs the user that the format of the attached file is not converted since the format is unclear. One example of the notification message is a string of characters which is inserted into a location immediately preceding a display of information contained in the attached file at the end of main contents. The notification message states: “The format of the attached file was not converted since the format is unclear.” If the outcome of the judgment formed at the step S34 indicates that the format of the attached file is clear, on the other hand, the flow of the processing goes on to a step S35 at which the format of the attached file is converted. Then, at the next step S36, the attached file is replaced by a file having a format obtained as a result of the conversion. Finally, at the step S38, the received email is put in the user's mailbox in the user storage area.

A program executed to carry out a sequence of processes described above is installed in the mail server 183 initially or later. Storage media for storing the program in a form executable in the mail server 183 is not limited to package media, but can also be a semiconductor memory or a magnetic disk capable of storing the program temporarily or permanently. Examples of the package media are a floppy disk, a CD-ROM (Compact Disk Read-Only Memory) and a DVD (Digital Versatile Disk).

As a means for storing the program into these pieces of program storage media, it is possible to use wire or wireless communication media such as a local area network, the Internet and digital satellite broadcasting. As an alternative, the program can also be stored through a variety of communication interfaces such as a router and a modem.

A preferred embodiment of the present invention has been described so far. It should be noted, however, that a variety of changes and modifications can be made to the preferred embodiment described above. For example, menu configurations and menu items which are shown in the figures are just typical. The menu configurations and the menu items can thus be implemented differently. That is to say, instead of representing each of the menu items by using an icon, the menu items can also be displayed as a list menu, a pull-down menu or a pop-up menu. In addition, if a data communication function is added to the PDA 10, a communication apparatus such as the mobile phone 15 does not have to be provided. As described above, the mail viewing machine does not have to be a PDA. Instead, it is possible to use any information apparatus including mail client software as a mail viewing machine. Examples of such information apparatus are a personal computer (PC), a mail terminal and a game machine.

Even though a mail server of the Internet is used for exemplifying the embodiment, the present invention can also be applied to a mail server of an intranet in an organization such as a corporation.

While a preferred embodiment of the present invention has been described using specific terms, such description is for illustrative purposes only, and it is to be understood that changes and variations may be made without departing from the spirit or scope of the following claims.

What is claimed is:

1. An information presenting apparatus comprising:
format recognizing means for recognizing a type of a format of an attached file attached to an email destined for a user cataloged in advance;
format conversion processing means which is used for converting said format of said attached file into a particular standard format pertaining to a second format group set in advance if said format of said attached file is recognized by said format recognizing means to be a format pertaining to a first format group set in advance; and
file replacement processing means for replacing said attached file attached to said email with another attached file having said particular standard format produced by said format conversion processing means as a result of format conversion.

2. An information presenting apparatus according to claim 1 wherein said format recognizing means recognizes a type of said format of said attached file on the basis of an extension of a file name given to said attached file.

3. An information presenting apparatus according to claim 2 wherein said first format group is a group of formats for a variety of text files.

4. An information presenting apparatus according to claim 3 wherein said standard format is a PDF (Portable Document Format).

5. An information presenting apparatus according to claim 2 wherein said first format group is a group of formats for a variety of picture files.

6. An information presenting apparatus according to claim 2 wherein said first format group is a group of formats for a variety of audio files.

7. An information presenting apparatus according to claim 1, said information presenting apparatus further including:
mail preserving means for preserving emails destined for users cataloged in advance; and
message inserting means which is used for inserting a notification message into main contents of any particular one of said emails preserved in said mail storing means to indicate that no format conversion was carried out if a format of an attached file attached to said particular email is recognized by said format recognizing means to be not a format pertaining to said first format group set in advance.

8. An information presenting apparatus according to claim 1 wherein:
said information presenting apparatus further includes storage means for storing formats which pertain to said first format group but are not to be subjected to format conversion as desired by the user; and
said format conversion processing means does not convert a particular format of an attached file if said particular format is one of said formats stored in said storage means and, hence, subjected to no format conversion.

9. An information presenting method comprising:
a format recognizing step of recognizing a type of a format of an attached file attached to an email destined for a user cataloged in advance;
a format conversion processing step which is executed for converting said format of said attached file into a particular standard format pertaining to a second format group set in advance if said format of said attached file is recognized at said format recognizing step to be a format pertaining to a first format group set in advance; and
a file replacement processing step of replacing said attached file attached to said email with another attached file having said particular standard format produced at said format conversion processing step as a result of format conversion.

10. A information presentation processing program storage medium for storing a program executable by a computer to present information, said program comprising:
a format recognizing step of recognizing a type of a format of an attached file attached to an email destined for a user cataloged in advance;
a format conversion processing step which is executed for converting said format of said attached file into a particular standard format pertaining to a second format group set in advance if said format of said attached file is recognized at said format recognizing step to be a format pertaining to a first format group set in advance; and
a file replacement processing step of replacing said attached file attached to said email with another attached file having said particular standard format produced at said format conversion processing step as a result of format conversion.
